(19) United States
(12) Patent Application Publication
(10) Pub. No.: US 2011/0052316 A1
(43) Pub. Date: Mar. 3, 2011

(54) Spline Shaft Assembly

(75) Inventor: Feng-Tien CHEN, Taichung City (TW)

(73) Assignee: Sheng-Hui Wang, Taichung County (TW)

(21) Appl. No.: 12/547,430

(22) Filed: Aug. 25, 2009

(51) Int. Cl. F16D 3/06

(52) U.S. Cl. 403/356

(57) ABSTRACT

A spline shaft assembly includes a rotatable shaft extending along an axial direction and having an outer surface, and a plurality of first grooves formed in the outer surface. A transmission module is formed with a through hole and has an inner surface defining the through hole, and a plurality of axially extending second grooves formed in the inner surface. Each of the first and second grooves is defined by a semi-circular groove-defining wall. The rotatable shaft extends through the through hole. A spline key set has a plurality of cylindrical keys extending along the axial direction and disposed between and engaging the first grooves and the second grooves, and at least two positioning members connected to the transmission module and associated with the cylindrical keys such that the transmission module and the cylindrical keys are co-rotatable.

### BACKGROUND OF THE INVENTION

1. Field of the Invention

The invention relates to a spline shaft, more particularly to a spline shaft assembly capable of transmitting torque.

2. Description of the Related Art

Referring to FIGS. 1 and 2, a conventional spline shaft assembly 1 comprises a rotatable shaft 11 extending along an axial direction (X), and a transmission member 12 configured as a spur gear. The rotatable shaft 11 has an outer surface and a plurality of keys 111 formed in the outer surface of the rotatable shaft 11. The transmission member 12 is formed with a through hole 121 and has an inner surface defining the through hole 121, and a plurality of axially extending grooves 122 formed in the inner surface of the transmission member 12. The rotatable shaft 11 extends through the through hole 121. The keys 111 of the rotatable shaft 11 engage respectively the grooves 122 of the transmission member 12 such that the rotatable shaft 11 and the transmission member 12 are co-rotatable.

The grooves 122 of the conventional spline shaft assembly 1 may be formed by a cutting piece 2 that rotates about a transverse axis (Y) perpendicular to the axial direction (X) to thereby grind or mill the inner surface of the transmission member 12. However, if the through hole 121 is too narrow to allow extension of a driving device that drives the cutting piece 2 to rotate, the grooves 122 can be formed only by broaching.

When it is desired to form the grooves 122, a broach of a broaching machine (not shown) is extended through the through hole 121 to broach the inner surface of the transmission member 12. However, the broaching machine is expensive, and the cutting amount thereof per unit time is relatively small (approximately 0.02 mm). Furthermore, the rectangular groove-defining walls of the grooves 12 deform easily after a heat-treatment is applied. As such, the rotatable shaft 11 must be machined to engage fittingly the grooves 12, which results in a troublesome manufacturing process for the conventional spline shaft assembly 1. Once the rotatable shaft 11 and the grooves 12 of the transmission member 12 do not engage fittingly, unwanted noise and vibration will be generated to thereby reduce the operating efficiency of the conventional spline shaft assembly 1.

Referring to FIG. 3, a conventional ball-bearing type spline shaft 3 comprises a rotatable shaft 31, a transmission member 32, a retaining member 33 co-rotatable with the transmission member 32, and a plurality of balls 34. The rotatable shaft 31 has a plurality of axially extending grooves 311 formed in an outer surface thereof. The transmission member 32 has a plurality of axially extending grooves 321 formed in an inner surface thereof. The grooves 311, 321 receive the balls 34 therein. Since the balls 34 are in point contact with the transmission member 32 and the rotatable shaft 31, the retaining member 33 is required to maintain the balls 34 within the grooves 311, 321. The retaining member 33 has a plurality of through holes 331 arranged along the axial direction (X) for receiving the balls 34, respectively. The configuration of the ball-bearing spline shaft 3 is complicated and the installation of the ball-bearing spline shaft 3 is cumbersome.

### SUMMARY OF THE INVENTION

Therefore, the object of the present invention is to provide a spline shaft assembly capable of alleviating the above drawbacks of the prior art.

Accordingly, a spline shaft assembly of the present invention comprises a rotatable shaft extending along an axial direction, and having an outer surface, and a plurality of first grooves formed in the outer surface. Each of the first grooves is defined by a semi-circular groove-defining wall. A transmission module is formed with a through hole and has an inner surface defining the through hole, and a plurality of axially extending second grooves formed in the inner surface of the transmission module. Each of the second grooves is defined by a semi-circular groove-defining wall. The rotatable shaft extends through the through hole. A spline key set has a plurality of cylindrical keys extending along the axial direction and disposed between and engaging the first grooves of the rotatable shaft and the second grooves of the transmission module, and at least two positioning members connected to the transmission module and associated with the cylindrical keys such that the transmission module and the cylindrical keys are co-rotatable.

The spline shaft assembly of the present invention is easier to construct compared to the conventional spline shaft assemblies.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional spline shaft assembly;

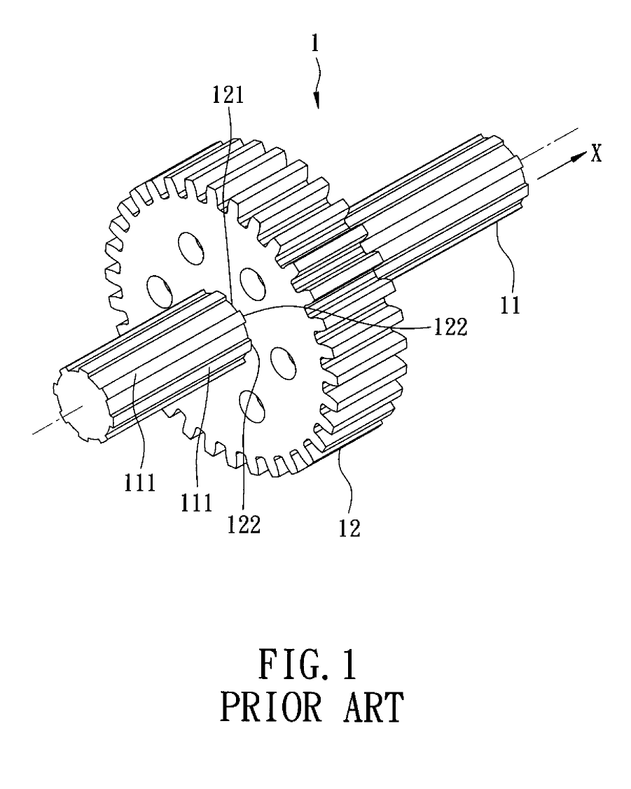

FIG. 2 is a schematic view of a transmission member of the spline shaft assembly of FIG. 1;

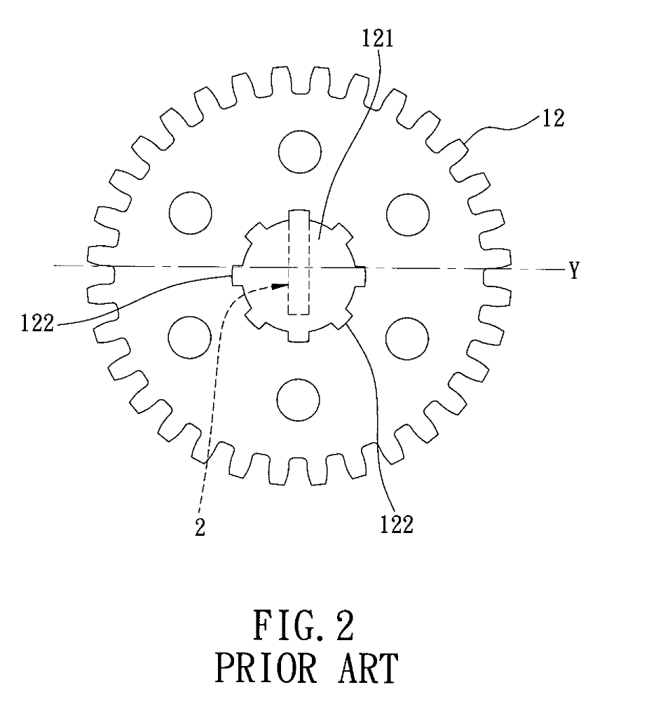

FIG. 3 is a partly cutaway perspective view of another conventional spline shaft assembly;

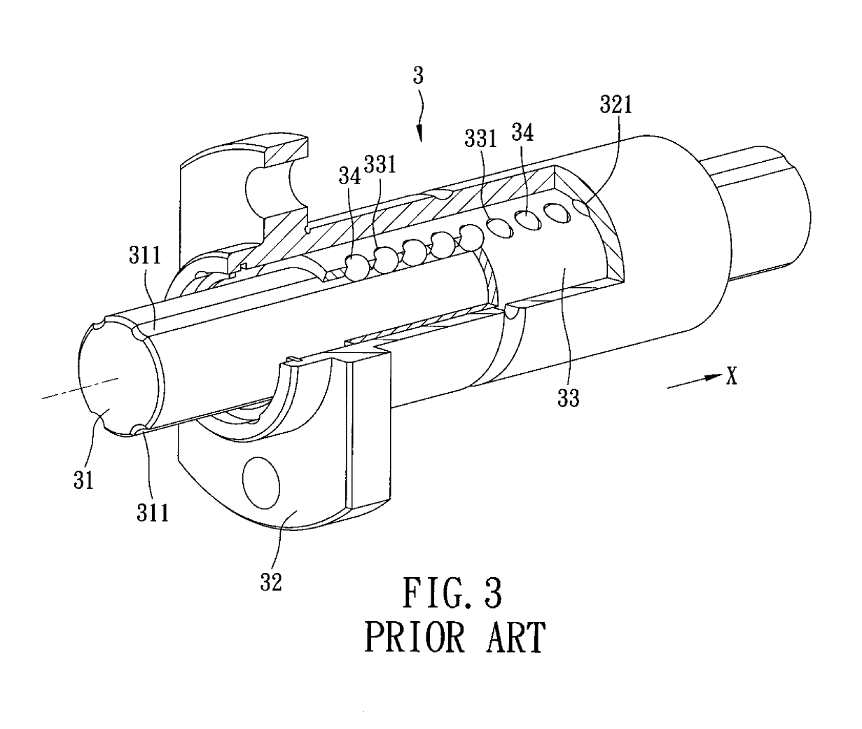

FIG. 4 is an exploded perspective view of a first preferred embodiment of a spline shaft assembly of the present invention;

FIG. 5 is a partly cutaway perspective view of the first preferred embodiment of the present invention;

FIG. 6 is a partly cutaway perspective view of a second preferred embodiment of a spline shaft assembly according to the present invention;

FIG. 7 is a partly cutaway perspective view illustrating a modified transmission member of the second preferred embodiment; and

FIG. 8 is a partly cutaway perspective view of a third preferred embodiment of a spline shaft assembly according to the present invention.

### DETAILED DESCRIPTION OF THE PREFERRED EMBODIMENTS

Before the present invention is described in greater detail, it should be noted that like elements are denoted by the same reference numerals throughout the disclosure.

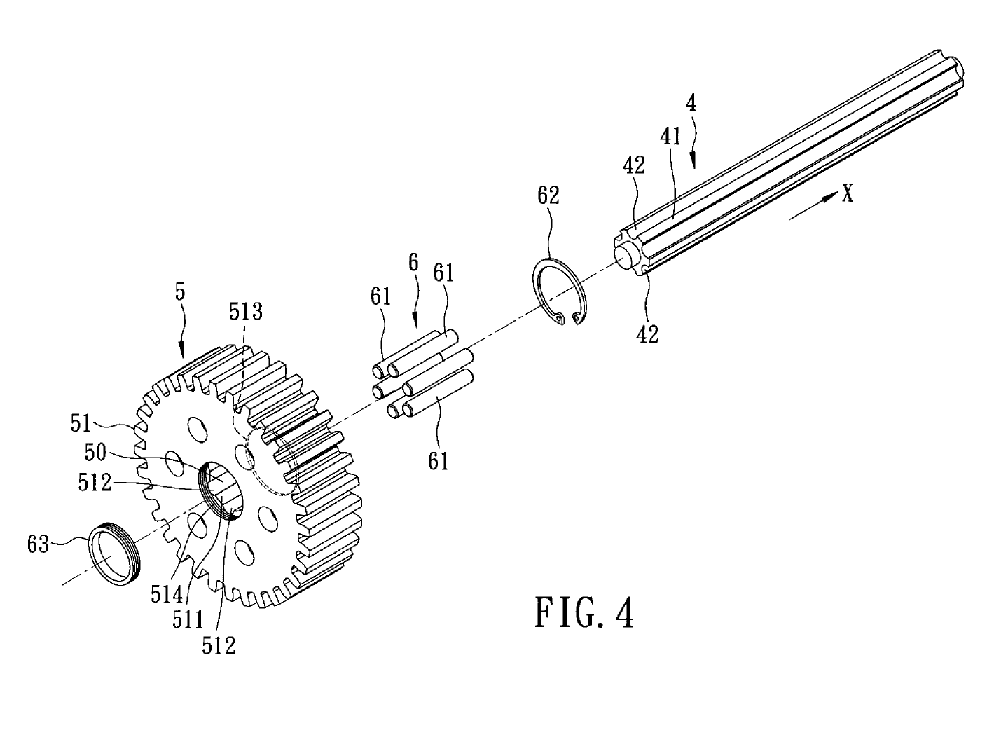

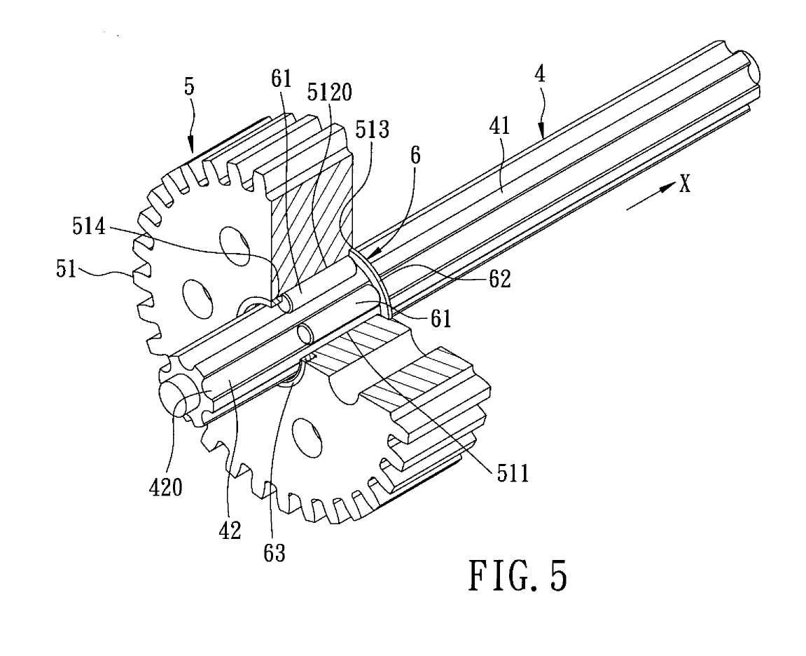

As shown in FIGS. 4 and 5, a first preferred embodiment of a spline shaft assembly according to the present invention comprises a rotatable shaft 4, a transmission module 5, and a spline key set 6.

The rotatable shaft 4 extends along an axial direction (X), and has an outer surface 41, and a plurality of first grooves 42 formed in the outer surface 41. Each of the first grooves 42 is defined by a semi-circular groove-defining wall 420.

The transmission module 5 has a transmission member 51 configured as a spur gear in this embodiment. The transmission member 51 is formed with a through hole 50, and has an inner surface 511 defining the through hole 50, and a plurality of axially extending second grooves 512 formed in the inner surface 511. Each of the second grooves 512 is defined by a semi-circular groove-defining wall 5120. The rotatable shaft 4 extends through the through hole 50. The transmission member 51 has an annular groove 513 formed in the inner surface 511 and disposed at one end of the transmission member 51, and an internally threaded portion 514 formed at the other end of the transmission member 51.

The spline key set 6 has a plurality of cylindrical keys 61 and two positioning members configured respectively as a C-ring 62 and an externally threaded fastener 63. The keys 61 of the spline key set 6 extend along the axial direction (X), and are disposed between and engage the first grooves 42 of the rotatable shaft 4 and the second grooves 512 of the transmission member 51. The positioning members are connected to the transmission member 51 and are associated with the cylindrical keys 61 such that the transmission member 51 and the cylindrical keys 61 are co-rotatable. The transmission member 51 and the rotatable shaft 4 are interconnected co-rotatably through the cylindrical keys 61 and the positioning members (i.e., the C-ring 62 and the fastener 63). Through engagement between the keys 61 and the first and second grooves 42, 512, the rotatable shaft 4 and the transmission member 51 can slide relative to each other along the axial direction (X).

The C-ring 62 engages the annular groove 513 and abuts against one end of each of the cylindrical keys 61. The fastener 63 engages the internally threaded portion 514 of the transmission member 51 and abuts against the other end of each of the cylindrical keys 61.

It should be noted that a grinder (not shown) is employed as a manufacturing tool in this embodiment. A spindle (not shown) of the grinder extends through the through hole 50 and rotates about an axis parallel to the axial direction (X) to thereby grind the inner surface 511 of the transmission member 51 to form one of the second grooves 512 at a time.

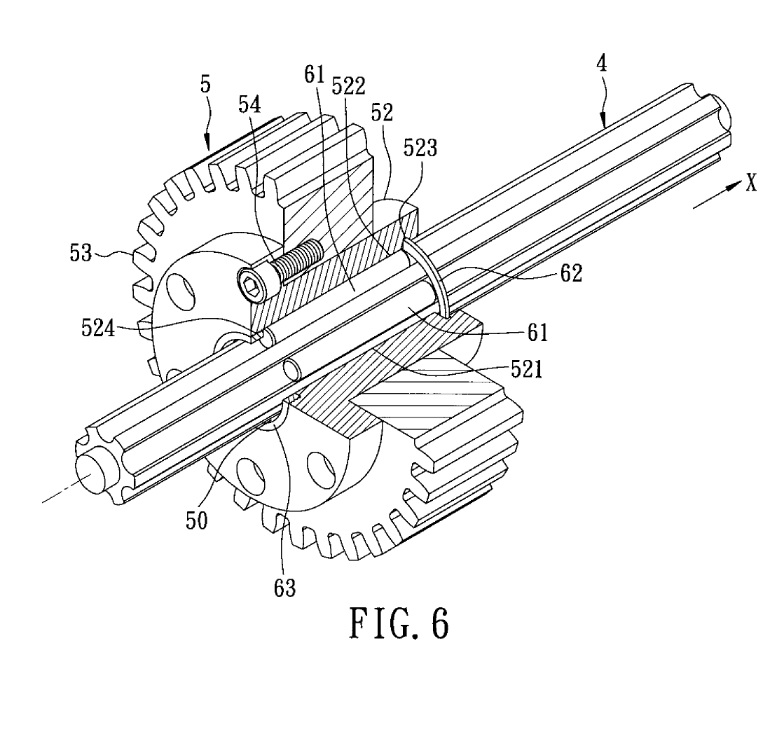

As shown in FIG. 6, a second preferred embodiment of the spline shaft assembly according to the present invention has a structure similar to that of the first embodiment. The main difference between this embodiment and the first embodiment resides in the following. The transmission module 5 has a transmission member 53 and a shaft sleeve 52 surrounded by the transmission member 53 and formed with the through hole 50. The transmission member 53 is connected co-rotatably to the shaft sleeve 52 by a plurality of screws 54 (only one is shown). The transmission member 53 is configured as a spur gear. The shaft sleeve 52 has an inner surface 521, a plurality of axially extending second grooves 522 formed in the inner surface 521, an annular groove 523 formed in the inner surface 521 and disposed at one end of the shaft sleeve 52, and an internally threaded portion 524 formed at the other end of the shaft sleeve 52. Each of the second grooves 522 is defined by a semi-circular groove-defining wall. The rotatable shaft 4 extends through the through hole 50.

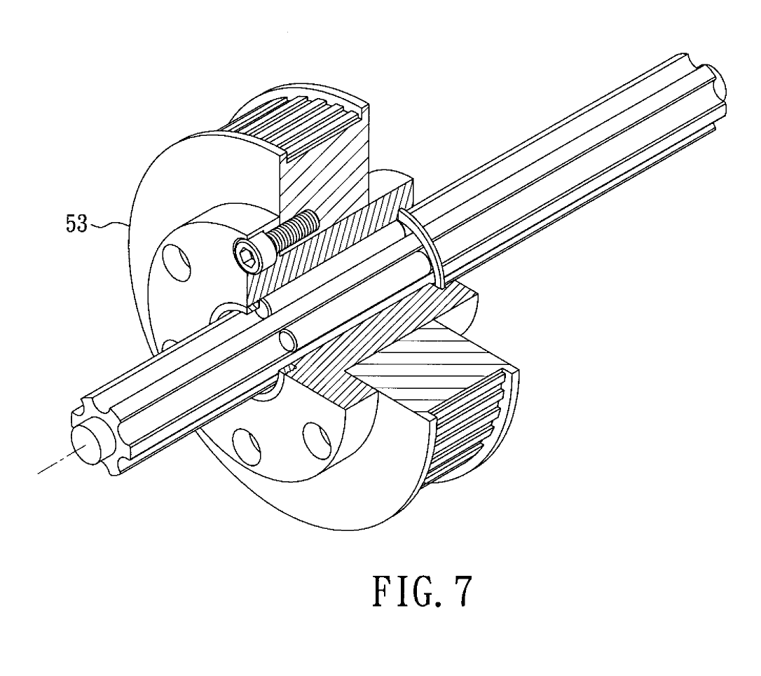

The positioning members are configured respectively as a C-ring 62 and an externally threaded fastener 63. The C-ring 62 engages the annular groove 523 and abuts against one end of each of the cylindrical keys 61. The fastener 63 engages the internally threaded portion 524 of the shaft sleeve 52 and abuts against the other end of each of the cylindrical keys 61, such that the transmission member 53 and the cylindrical keys 61 are co-rotatable. The second preferred embodiment has the same advantages as those of the first preferred embodiment. As shown in FIG. 7, a modified transmission member 53 is configured as a belt pulley.

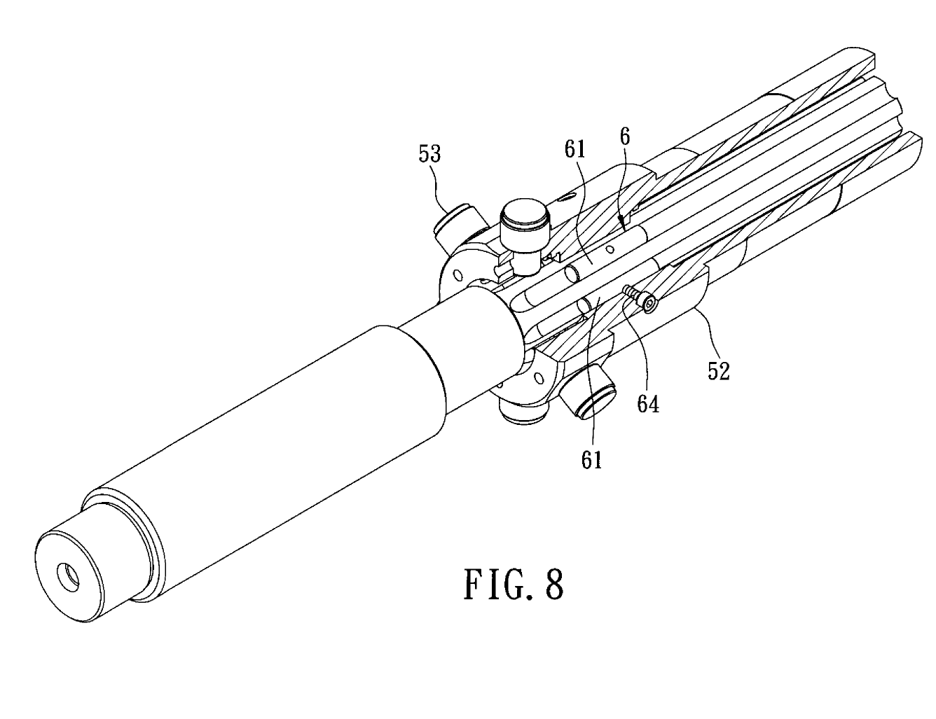

Referring to FIG. 8, a third preferred embodiment of the spline shaft assembly according to the present invention has a structure similar to that of the second embodiment. The main difference between the third embodiment and the second embodiment resides in the following. The transmission member 53 includes a plurality of angularly equidistant camshafts connected fixedly to and extending radially and outwardly from the shaft sleeve 52. The spline key set 6 has a plurality of the positioning members each configured as a radially extending screw 64. The screws 64 (only one is shown) of the spline key set 6 extend through the shaft sleeve 52 and are threaded respectively to the keys 61, such that the keys 61, the shaft sleeve 52 and the transmission member 53 are co-rotatable. The annular groove 523 (shown in FIG. 6) of the shaft sleeve 52 and the internally threaded portion 524 (shown in FIG. 6) of the shaft sleeve 52 are omitted in this embodiment. The third preferred embodiment has the same advantages as those of the second preferred embodiment.

To sum up, the advantages of the spline shaft assembly according to the present invention are as follows. The second grooves 512, 522 are formed by a grinding process that simplifies the manufacturing process and decreases the manufacturing costs of the spline shaft assembly. Therefore, the spline shaft assembly of the present invention is easier to construct compared the conventional spline shaft assemblies.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A spline shaft assembly comprising:
a rotatable shaft extending along an axial direction and having an outer surface, and a plurality of first grooves formed in said outer surface, each of said first grooves being defined by a semi-circular groove-defining wall;
a transmission module being formed with a through hole and having an inner surface defining said through hole, and a plurality of axially extending second grooves formed in said inner surface of said transmission module, each of said second grooves being defined by a semi-circular groove-defining wall, said rotatable shaft extending through said through hole;
a spline key set having a plurality of cylindrical keys extending along the axial direction and being disposed between and engaging said first grooves of said rotatable shaft said and said second grooves of said transmission module, and at least two positioning members connected to said transmission module and associated with said cylindrical keys such that said transmission module and said cylindrical keys are co-rotatable.

2. The spline shaft assembly as claimed in claim 1, wherein said transmission module is configured as a spur gear.

3. The spline shaft assembly as claimed in claim 2, wherein said transmission module further has an annular groove formed in said inner surface and disposed at one end of said transmission module, and an internally threaded portion formed at the other end of said transmission module, said positioning members being configured respectively as a C-ring and an externally threaded fastener, said C-ring engaging said annular groove and abutting against one end of each of said cylindrical keys, said fastener engaging said internally threaded portion of said transmission module and abutting against the other end of each of said cylindrical keys.

4. The spline shaft assembly as claimed in claim 1, wherein said transmission module further has a transmission member and a shaft sleeve surrounded by said transmission member and formed with said through hole, said transmission member being connected to and being co-rotatable with said shaft sleeve.

5. The spline shaft assembly as claimed in claim 4, wherein said spline key set has a plurality of said positioning members each configured as a radially extending screw, said screws of said spline key set extending through said shaft sleeve and being threaded respectively to said keys.

6. The spline shaft assembly as claimed in claim 4, wherein said shaft sleeve is further formed with an annular groove formed in said inner surface and disposed at one end of said shaft sleeve, and an internally threaded portion formed at the other end of said shaft sleeve, said positioning members being configured respectively as a C-ring and an externally threaded fastener, said C-ring engaging said annular groove and abutting against one end of each of said cylindrical keys, said fastener engaging said internally threaded portion of said shaft sleeve and abutting against the other end of each of said cylindrical keys.

7. The spline shaft assembly as claimed in claim 4, wherein said transmission member is configured as one of a spur gear and a belt pulley.

8. The spline shaft assembly as claimed in claim 4, wherein said transmission member includes a plurality of angularly equidistant camshafts connected fixedly to and extending radially and outwardly from said shaft sleeve.
